(19) United States
(12) Patent Application Publication
(10) Pub. No.: US 2006/0117334 A1
(43) Pub. Date: Jun. 1, 2006

(54) Disk drive provided with optical pickup unit

(76) Inventor: Takeshi Makino, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/288,297

(22) Filed: Nov. 29, 2005

(30) Foreign Application Priority Data
Nov. 29, 2004 (JP) 2004-343732

(51) Int. Cl. G11B 7/085; G11B 7/08; G11B 7/09

(52) U.S. Cl. 720/667

(57) ABSTRACT

In order to provide a disk drive not adversely influenced by a need of adjusting a guide shaft caused by a warp and mounting error in a chassis, a support base is mounted and fixed over two guide shafts along which an optical pickup unit moves, and a spindle motor having a turntable is fixedly mounted on the support base.

### BACKGROUND OF THE INVENTION

1. Field of the Invention

The present invention relates to a disk drive in which a spindle motor is mounted on guide shafts along which an optical pickup unit moves.

2. Related Art

A traverse unit of a disk drive is provided with an optical pickup unit and a turntable to be rotated by a spindle motor. The optical pickup unit irradiates light onto a disk mounted on the turntable and reads information recorded on the disk while moving along the guide shafts. Therefore, the reflected light cannot be read accurately unless the light irradiated from an optical pickup strike the disk surface correctly. Thus, the guide shafts to guide the optical pickup unit need to be in parallel to the recording surface of the disk with a predetermined distance therebetween. More specifically, the main shaft of the spindle motor and the main axis of an objective lens of the optical pickup unit need to be in parallel with each other. This is because when the main shaft of the spindle motor is tilted, the disk placed on the turntable mounted on the main shaft of the spindle motor is tilted and the distance to the objective lens is varied between at the outer rim part and at the inner rim part of the disk.

Then, in a traverse unit of a conventional disk drive, as shown in FIG. 5, a movable carriage 4 having an optical pickup unit 3 is slidably mounted on two guide shafts 2a and 2b which are placed over a traverse chassis 1 in parallel. On the other hand, a spindle motor on which a turntable 5 is mounted is fixed to the traverse chassis 1. Here, the traverse chassis 1 is formed of a metal thin plate. It is punched, bent, and shaped in a predetermined shape, thus often the traverse chassis 1 is warped as a whole or partially deformed. Since two guide shafts 2a and 2b are mounted on such traverse chassis 1, both ends of the guide shafts 2a and 2b are not fully fixed, but one end is formed as a support structure having an adjusting mechanism 6 which allows to adjust its height for coping with fabrication error and mounting error.

More specifically, the height of the guide shafts 2a and 2b is adjusted by the adjusting mechanisms 6 and 6 so that the main shaft of the spindle motor fixed to the traverse chassis 1 and the main axis of the objective lens of the optical pickup unit 3 are in parallel with each other, and thus a parallelism (skew) adjustment is carried out between the main axis of the objective lens of the optical pickup unit and the main shaft of the spindle motor. However, this adjustment requires skills as well as time and also requires an exclusive adjustment jig such as the adjust mechanism 6, and accordingly it is considered to be one of troublesome steps in assembly work for the disk drive.

Furthermore, JP-A-2000-222803 disdoses an “optical disk drive” in which a turntable, a first motor (spindle motor) for its drive, an optical pickup and its driving mechanism are installed on a traverse base (traverse chassis) as a separate body from an apparatus base which can be turned up and down, wherein the spindle motor is directly screwed to the traverse chassis, and the bit of the main shaft of the spindle motor is corrected by adjusting a guide on which the optical pickup is mounted.

JP-A-2004-280983 disdoses a “disk device” in which a disk motor is mounted on a metal fixed chassis, an optical pickup is mounted on a movable chassis, the movable chassis has a tilt mechanism on one end in the direction orthogonal to the moving direction of-the optical pickup, wherein the main axis of an objective lens disposed on the optical pickup is adjusted for a parallelism with the main shaft of the disk motor. Also in this case, the device has the structure in which the disk motor (spindle motor) is fixed to the chassis and the optical pickup is positioned to the main shaft of the spindle motor.

As described above, since the spindle motor is fixed to the chassis in both of JP-A-2000-222803 and JP-A-2004-280983, the troublesome skew adjustment is needed after assembly because of a warp and mounting error in the chassis.

### SUMMARY OF THE INVENTION

Then, an object of the invention is to provide a disk drive not adversely influenced by a need of adjusting skews due to height adjustment of a guide shaft caused by a warp and mounting error in a chassis after assembly of the drive and other adverse influences.

In order to achieve the object, a disk drive according to the invention includes two guide shafts disposed on a traverse chassis of a traverse unit in parallel, and an optical pickup unit movably mounted along the guide shafts, wherein a support base is fixedly mounted over the two guide shafts, and the support base is provided with a spindle motor having a turntable on which a disk is placed for rotation.

Although both ends of the guide shafts are supported by a resin support part, the guide shafts are in parallel with each other and are mounted so as to be in parallel with the surface of the metal traverse chassis in order to permit the optical pickup unit movable. Since both of the optical pickup unit and the spindle motor are mounted on the same guide shafts, the relative position between the optical pickup unit and the spindle motor can be maintained accurately, and a parallelism between the main shaft of the spindle motor and the main axis of the objective lens provided to the optical pickup unit can be secured. Therefore, skew adjustment is not always necessary that is done by providing an adjusting mechanism at the tip end of the guide shaft as before.

The support base may be provided with an adjustment plate to form a predetermined space between the adjustment plate and the support base by interposing an energizing module to provide energizing force in a direction away from the support base, the adjustment plate is provided with screws to adjust level of the adjustment plate, and the spindle motor is mounted on the adjustment plate. With this configuration, a vertical level of the main shaft of the spindle motor is adjusted to permit an adjustment of a parallelism with the main axis of the objective lens. This allows correction in the case where error is generated caused by some factors.

Preferably, the adjustment plate is mounted above the support base through a space. This allows more effective use of space than the adjustment plate mounted below the support base, and contributes to a reduction of the thickness of the disk drive. Furthermore, the adjustment plate may be provided with three screws to adjust the space between the adjustment plate and the support base, so that the vertical level of the adjustment plate can be adjusted at a full angle of 360 degrees with respect to the main shaft of the spindle motor.

According to the disk drive of the invention, the relative position between the optical pickup unit and the spindle motor can be maintained accurately, and accordingly a parallelism between the main shaft of the spindle motor and the main axis of the objective lens of the optical pickup unit can be secured easily. Therefore, skew adjustment is not always necessary that has been done by providing an adjusting mechanism at the tip end of the guide shaft as before, contributing to a reduction in fabrication cost.

Furthermore, by mounting the spindle motor on the adjustment plate, it allows simple skew adjustment even when an error is generated by some factors.

### BRIEF DESCRIPTION OF THE DRAWING

FIG. 1 is a plan view illustrating the essential part of a traverse unit of a disk drive of a first embodiment according to the invention;

FIG. 2 is a vertical cross-section illustrating a mode of mounting an optical pickup unit on the traverse unit;

FIG. 3 is a plan view illustrating the essential part of a traverse unit of a disk drive of a second embodiment according to the invention;

FIG. 4 is a vertical cross-section illustrating a mode of mounting an optical pickup unit on the traverse unit; and

FIG. 5 is a plan view illustrating the essential part of a traverse unit of a conventional disk drive.

### DETAILED DESCRIPTION OF PREFERRED EMBODIMENT

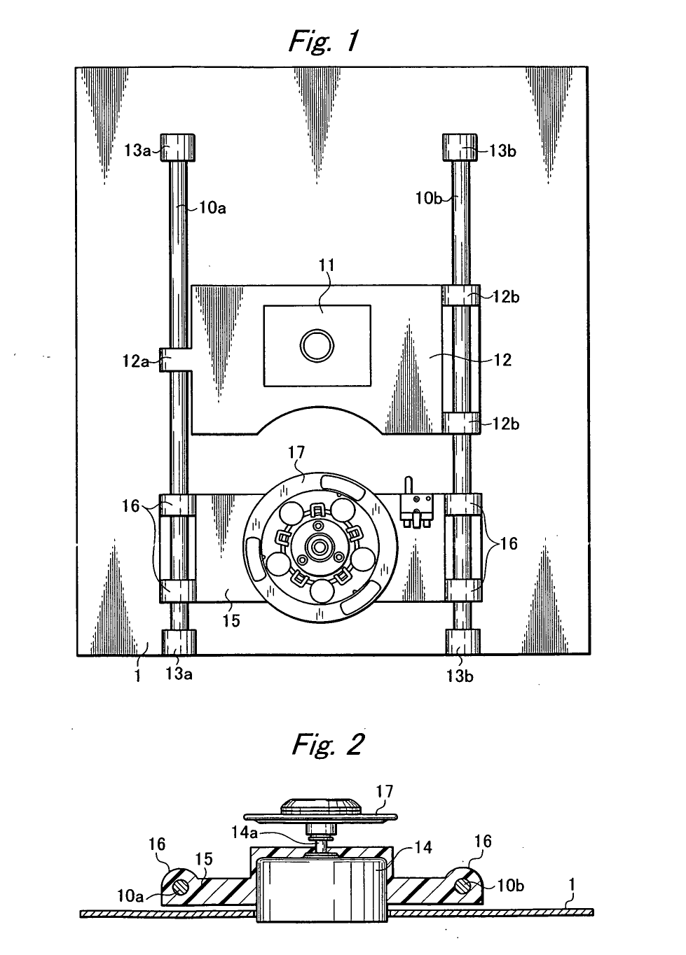

FIGS. 1 and 2 schematically show a traverse unit of a disk drive of a first embodiment according to the invention. An optical pickup unit 11 is movably mounted on two guide shafts 10a and 10b mounted over a metal traverse chassis 1 in parallel with each other. More specifically, a movable carriage 12 is disposed with straddling between the guide shafts 10a and 10b and movably along the guide shafts 10a and 10b, and the optical pickup unit 11 is mounted on the movable carriage 12. On one end side of the movable carriage 12, cylindrical bearing guides 12b and 12b are formed and slidably fit on the guide shaft 10b, and on the other end side, a U-shaped bearing guide 12a is formed and slidably fit on the guide shaft 10a.

Here, there is no limit to a moving module for the optical pickup unit 11, however, here, it is possible that a rack is provided on the movable carriage 12 to mount the optical pickup unit 11 thereon, and the rack is engaged with a pinion rotated by a motor and moved in accordance with the rotation of the pinion.

The guide shaft 10a is mounted at its both ends on support parts 13aand 13a erected from the traverse chassis 1, and is in parallel with the surface of the traverse chassis 1. Similarly, the guide shaft 10b is mounted at its both ends on support parts 13b and 13b, and is in parallel with the surface of the traverse chassis 1. Then, both of the guide shafts 10a and 10b are arranged in parallel with each other to permit the optical pickup unit 11 to move.

A spindle motor 14 is further mounted on the guide shafts 10a and 10b. More specifically, a support base 15 is fixedly supported over the guide shafts 10a and 10b, and the spindle motor 14 is fixed to the support base 15. Both ends of the support base 15 are fixedly mounted to mounting parts 16 at four places on the both ends thereof, but the shape and the mounting mode are not limited particularly. The support base 15 is shaped of a resin, and the spindle motor 14 is fit into a hole formed in the support base 15. A turntable 17 is mounted on a main shaft 14a projected upward.

In addition, although the support base 15 can be shaped by aluminum die casting other than resin shaping, the accuracy of the shaping dimensions is high. The main shaft 14a of the spindle motor 14 extends vertically toward the guide shafts 10a and 10b, and the mounting surface of the turntable 17 is in parallel with the plane including both of the guide shafts 10a and 10b.

Similarly, the accuracy of the shaping dimensions is high on the movable carriage 12 on which the optical pickup unit 11 is mounted. The main axis of an objective lens (not shown) provided on the optical pickup unit 11 is vertical to both of the guide shafts 10a and 10b. Because the objective lens is mounted on the same guide shafts 10a and 10b, the main axis of the objective lens is positioned in parallel with the main shaft 14a of the spindle motor 14 with no adverse influence from a warp and partial deformation in the traverse chassis 1, and consequently, the positions of the guide shafts 1 Oa and 10b do not need to be adjusted. More specifically, the optical pickup unit 11 and the spindle motor 14 are both mounted on the guide shafts 10a and 10b, and thus relative positioning is done accurately.

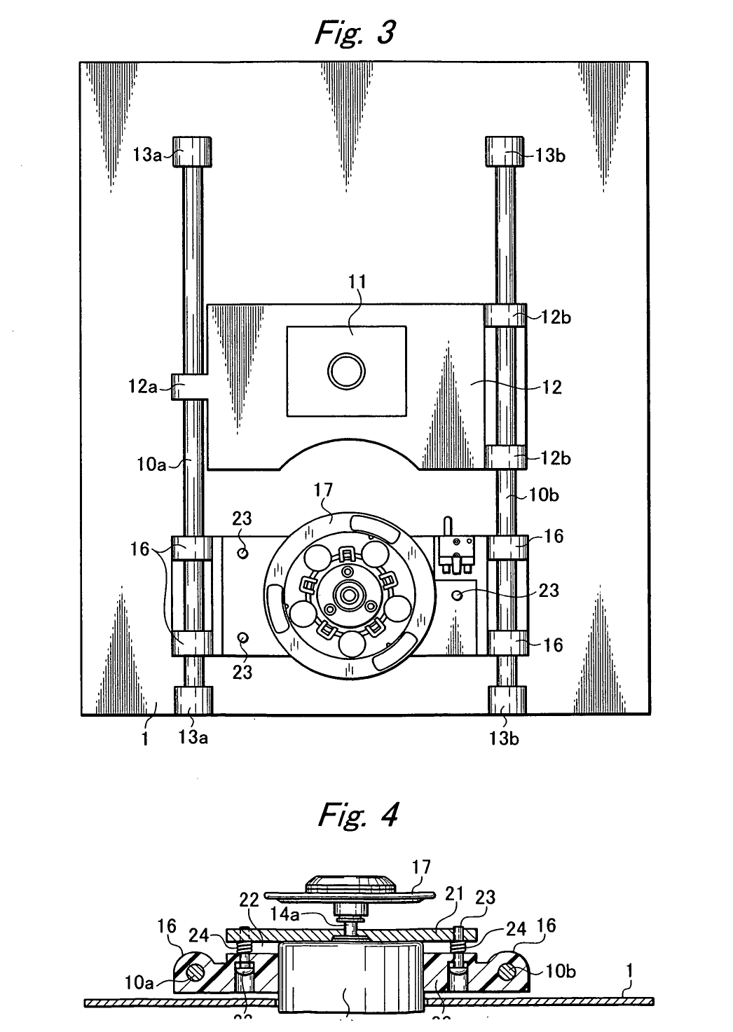

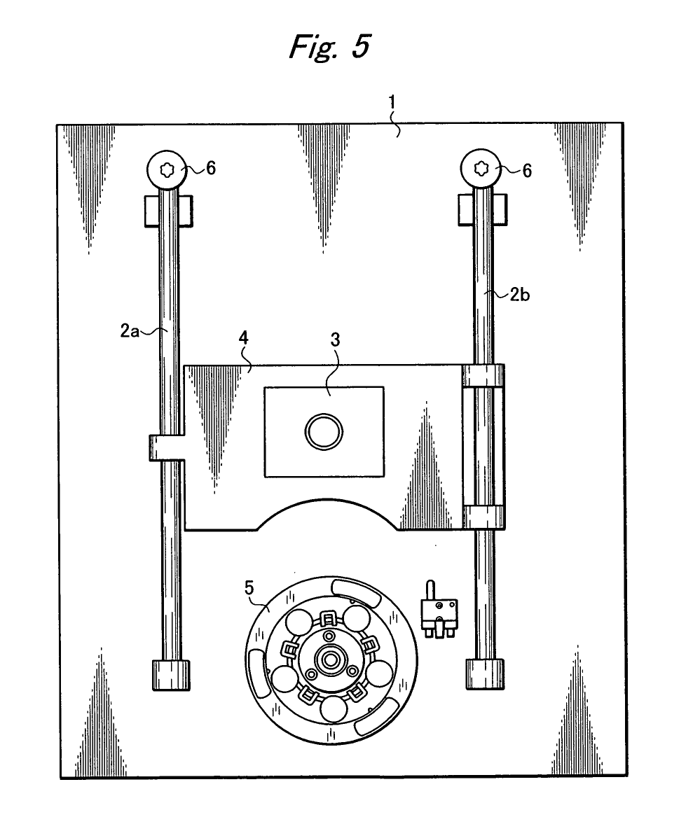

FIGS. 3 and 4 show a second embodiment according to the invention. The second embodiment is as same as the first embodiment in that a movable carriage 12 having an optical pickup unit 11 mounted thereon is movably supported by guide shafts 10a and 10b and a support base 20 mounted with a spindle motor 14 is fixedly supported over the guide shafts 10a and 10b. However, the second embodiment is different in that the support base 20 is combined with an adjustment plate 21.

The adjustment plate 21 is disposed above the support base 20 with a predetermined space 22 therebetween, and the spindle motor 14 is screwed and fixed to the adjustment plate 21. The space 22 is adjustable by three screws 23, 23 and 23. More specifically, the three screws 23, 23 and 23 are inserted from the support base 20 side and screwed to screw holes in the adjustment plate 21, and the plate is supported by coil springs 24,24 and 24 disposed in the space 22 between the support base 20 and the adjustment plate 21. Here, the coil springs 24, 24 and 24 energize spring force so as to lift the adjustment plate 21.

Therefore, when the screws 23 are fastened, the adjustment plate 21 is pulled toward the support base 20 side and then the space 22 becomes small, whereas when the screws 23 are loosened, the adjustment plate 21 is detached from the support base 20 and then the space 22 becomes greater. Thus, the three screws 23, 23 and 23 are appropriately adjusted to permit the level of the adjustment plate 21 to be regulated. The spindle motor 14 is screwed and fixed to the adjustment plate 21, and accordingly the vertical level of the main shaft 14a of the spindle motor 14 can be regulated by appropriately adjusting the screws 23, 23 and 23.

In the embodiment, as shown in FIG. 4, it is structured so that the adjustment plate 21 is supported above the support base 20 through the screws 23 and the ooil springs 24, but the adjustment plate 21 may be placed below the support base 20. In this case, the adjustment plate is hung by three screws and also provided with spring force to push it downward with the coil springs disposed in the space. In this manner, by interposing the coil springs, advantages are achieved that the adjustment plate is mounted stably with no ratte, and the screws are prevented from being loosened.

Although the spindle motor 14 supported by the guide shafts 10a and 10b on which the optical pickup unit 11 is mounted is correctlypositioned in principle, it is minutely adjusted as needed by the adjusting mechanism of the embodiment.

What is claimed is:

1. A disk drive comprising:
two guide shafts disposed on a traverse chassis of a traverse unit in parallel, and
an optical pickup unit movably mounted along the guide shafts,
wherein a support base is fixedly mounted over the two guide shafts, and
the support base is provided with a spindle motor having a turntable on which a disk is placed for rotation.

2. The disk drive according to claim 1, wherein the support base is provided with an adjustment plate to form a predetermined space between the adjustment plate and the support base by interposing an energizing module to provide energizing force in a direction away from the support base,
the adjustment plate is provided with screws to adjust level of the adjustment plate, and
the spindle motor is mounted on the adjustment plate.

3. The disk drive according to claim 2, wherein the adjustment plate is mounted above the support base through a space.

4. The disk drive according to claim 2, wherein the adjustment plate is provided with three screws to adjust the space between the adjustment plate and the support base.
